(19) United States
(12) Patent Application Publication
(10) Pub. No.: US 2009/0104388 A1
(43) Pub. Date: Apr. 23, 2009

(54) APPARATUS AND METHOD FOR OFFSET FOLDED POLYMERIC BAGS

(75) Inventors: George M. Hall, Colleyville, TX (US); Michael A. Ross, Dallas, TX (US)

Correspondence Address: AKIN GUMP STRAUSS HAUER & FELD, LLP, P O BOX 688, DALLAS, TX, 75313-0688, US

(73) Assignee: POLY-AMERICA, LP, Grand Prairie, TX (US)

(21) Appl. No.: 11/875,508

(22) Filed: Oct. 19, 2007

(51) Int. Cl. B32B 27/00

(52) U.S. Cl. 428/35.2

(57) ABSTRACT

The present invention provides an offset folded polymeric bag. The offset folding polymeric bag defines a plurality of layers, wherein the plurality of layers is divided into two sets of layers and a primary opening is defined between the two sets of layers. The first set of layers has a different width than the second set of layers to inform the consumer as to particular order for unfolding the bag with the least amount of difficulty, thereby preventing consumer frustration with thin film plastic bags.

### CROSS-REFERENCE TO RELATED APPLICATIONS

Not Applicable.

### BACKGROUND OF THE INVENTION

1. Technical Field of the Invention

The present invention relates generally to polymeric trash bags. More specifically, the present invention relates to a specific folded arrangement of a polymeric trash bag to facilitate simple, consistent opening of the bag by a consumer.

2. Description of the Related Art

Polymeric trash bags may be utilized in a wide variety of applications. Generally, the trash bags are manufactured using flexible thin polymeric film. More specifically, it is common to use a blown-film polymeric tube as the basic foundation for plastic bag manufacturing. The blown-film polymeric tube is provided with a carefully chosen diameter so that the circumference of the polymeric film serves as the side walls for the plastic trash bag. Given the variety of material thicknesses and tubular film dimensions that are possible, a variety of different sizes and configurations may be provided for various applications.

As plastics technology has evolved, the polymeric films used in the manufacture of trash bags and similar products have improved significantly. Over the years, the strength of polymeric films has increased substantially, allowing for thinner film to be used on a regular basis in many types of bags. The thinner bags are cheaper to manufacture, weigh less (which is beneficial for shipping purposes), and result in more bags fitting into the same-sized box. Unfortunately, as the polymeric film used in the manufacture of the bags becomes thinner, additional problems have surfaced that need to be addressed.

The manufacture of plastic bags, especially trash bags, using a blown-film process is well-known in the art. As the blown-film polymeric tube cools, the tube is flattened and a combination of seals, cuts, and perforations are provided depending on the final configuration of the bag. To minimize the footprint of the plastic trash bags for efficient packaging and sale, the bags are sometimes folded one or more times along the longitudinal axis of the film. This results in a series of bags of reduced width. After folding along the longitudinal axis, the bags may be separated individually and folded for packaging. Alternatively, the bags, either separated or in a continuous set, may be packaged as a cylindrical roll. Regardless of the method used in packaging the bag, the consumer will remove a single bag and open it for placement in a trash receptacle.

As previously noted, the thinner film has also introduced new problems, specifically with regard to how the trash bags are opened. Thicker polymeric films used in the construction of plastic bags typically have stiffer side walls, and the plastic film does not have a tendency to stick to itself. It is usually easy for the consumer to separate the film and unfold the bag so the upper opening can be used to expand the bag. Even if the bag is not fully unfolded, it is usually not a problem for a consumer to open the bag without much trouble. However, anyone having experience with various types of plastic trash bags will instantly recognize that thinner bags are not always as easily opened by the consumer.

Thinner bags are frequently twice-folded along the longitudinal axis, making it necessary to unfold the bag twice before opening the upper edge of the trash bag for placement in a receptacle. Unfortunately, thinner bags are not easily unfolded in the most efficient manner. The thin plastic makes it difficult for the consumer to identify the proper location for unfolding the bag. Furthermore, because of the thin plastic film used in the manufacture of some bags, the consumer may not completely unfold the bag prior to opening. If the consumer uses a jerking motion to put air in the bag, it is not uncommon for a bag that is not completely unfolded to tangle, reducing the capacity of the bag and requiring significantly more physical effort and time on the part of the consumer, which can result in user frustration. In the service industry, where many trash bags must be used on a regular basis, the amount of time lost to properly opening the bag can be significant. Therefore, it would be desirable to provide a simple means and mechanisms to assist a consumer in opening a thin film plastic trash bag in an efficient manner. It would be further desirable if the means or mechanism worked intuitively for the consumer, without requiring any express instructions. The present invention addresses those needs.

### SUMMARY OF THE INVENTION

The following description and the appended drawings set forth in detail certain illustrative embodiments of the present invention. These embodiments are only exemplars of but a few of the various ways in which the principles of the invention may be employed. There has thus been outlined, rather broadly, features of the invention in order that the detailed description thereof that follows may be better understood, and in order that the present contribution to the art may be better appreciated.

The present invention provides an offset folded polymeric bag. The offset folding polymeric bag is a special type of folded polymeric bag. A folded polymeric bag is formed from a flattened polymeric bag folded at least one time longitudinally. The folded polymeric bag defines a transverse width extending from a first side of the folded polymeric bag to a second side of the folded polymeric bag. The folded polymeric bag defines a plurality of layers, each of the plurality of layers being substantially parallel to one another. The plurality of layers is divided into a first set of layers and a second set of layers.

Embodiments of the folded polymeric bag of the present invention define a primary opening between the first set of layers and the second set of layers along a first side of the folded polymeric bag. Furthermore, in some embodiments the first set of layers and the second set of layers have a difference of width in the transverse direction. The difference of width in the transverse direction can vary, but is generally from 1 mm to 20 mm.

In other embodiments of the present invention, the first set of layers and the second set of layers are interconnected along a second side of the folded polymeric bag. Additionally, in certain embodiments the second set of layers of the offset folded polymeric bag may be further divided into a first subset of layers and a second subset of layers. In these embodiments, a secondary opening may be defined between these two subsets and each of the subsets may have a difference of width in the transverse direction which may, in some embodiments, be less than 10 mm.

Furthermore, the present invention provides a method for providing an offset folded polymeric bag. The method of the present invention may include providing a polymeric bag that in initially flat having a longitudinal direction and a transverse direction, and folding the polymeric bag transversely over a longitudinal line to provide the offset folded polymeric bag. The offset folded polymeric bag has a first edge that is farther from the first longitudinal line than a second edge.

### DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

FIG. 1A depicts a perspective view of the upper edge of a double-V folded thin film polymeric bag as known in the prior art.

FIG. 1B depicts a perspective view of the upper edge of a double-V folded thin film polymeric bag that has been properly unfolded a first time as known in the prior art.

FIG. 1C depicts a perspective view of the upper edge of a double-V folded thin film polymeric bag that has been unfolded a first time as known in the prior art.

FIG. 1D depicts a perspective view of the upper edge of a double-V folded thin film polymeric bag that has been unfolded a second time as known in the prior art.

FIG. 1E depicts a perspective view of a thin film plastic bag tangled after an unsuccessful attempt to open the bag as depicted in FIG. 1D.

FIG. 2A depicts a perspective view of the upper edge of a double-V folded thin film plastic bag according to an embodiment of the present invention.

FIG. 2B depicts a perspective view of the upper edge of an offset double-V folded thin film plastic bag according to an embodiment of the present invention wherein the bag has been unfolded a first time.

### DETAILED DESCRIPTION OF THE DRAWINGS

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

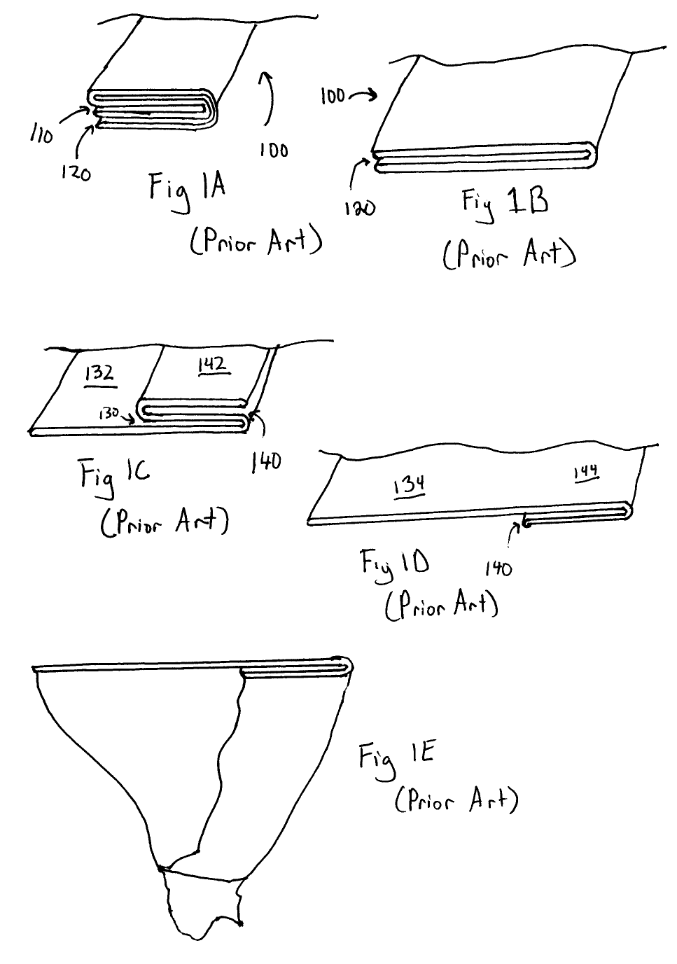

Referring to FIG. 1A, a ordinary doubled V-fold bag 100 as known in the prior art is depicted in a perspective view, looking primarily at the upper edge, or opening, of the bag. The prior art double V-fold bag illustrates how an ordinary consumer will likely attempt to open the bag at one of two places, the preferred location indicated by 110 and another opening indicated by 120. After opening the bag at location 110, FIG. 1B illustrates that the resulting configuration of the bag after unfolding a single time will make it easier to now use the second opening 120 to unfold the bag properly. The result is a properly opened bag with no consumer frustration. However, in practical day-to-day use, it is almost as likely that a consumer will open the bag of FIG. 1A at location 120 before 110, making it significantly more difficult to open the bag fully as better illustrated with reference to FIGS. 1C and 1D.

FIG. 1C depicts a bag according to FIG. 1A first opened at location 120. The resulting bag has been unfolded a single time, but is not balanced, having a three layer portion 142 on the right side and a single layer portion 132 on the left side. Because of the thin nature of the plastic used to manufacture these bags, it may be difficult to a consumer to recognize the opening at locations 130 and 140. Even if a consumer is lucky enough to find the opening at 140 and open that portion of the bag next, the consumer is again left with the bag depicted in FIG. 1B which can be easily opened, but at this point the consumer has unfolded the bag twice, not once, and is more frustrated. However, it is much more likely that a consumer will continuing to open at location 130.

The consumer will likely open the bag at 130 for several reasons. First, as thin plastic bags can be partially translucent, the difference in appearance and thickness between the one layer section 132 and the three-layer section 142 makes it more likely that the consumer will identify the opening at 130 in the middle of the bag, rather than the opening 140. After the consumer opens the bag at location 130, the bag is not much closer to being completely unfolded. Additionally, the opening at 130 is on the side exposed by opening 120, making the consumer that much more likely to open that portion. After this second unfolding, the resulting bag will look similar to the depiction of FIG. 1D.

Referring now to FIG. 1D, it is clear that the resulting configuration is still not completely unfolded. After two unfolding operations by the consumer, the bag is still not ready for use. This experience can cause consumer frustration with the product. Furthermore, the remaining opening 140 is now located on the side opposite the side exposed by unfolding at opening 130. Assuming the consumer is holding the bag in front of him or her, the consumer bag must rotate, or reverse, the bag to access the opening 140. Furthermore, since the consumer has already unfolded the bag twice, he or she may mistakenly believe the bag is already fully opened. Unlike the aspects of the bag described with reference to FIG. 1C, specifically the differences in appearance between the single layer portion 132 and the triple layer portion 142, a consumer is much less likely to notice the difference in appearance between the single layer portion 134 and the double layer portion 144. Therefore, it is expected that many frustrated consumers may attempt to open the bag at that point, which frequently results in a tangling of the plastic film of the bag as depicted in FIG. 1E. The consumer is required to spend extensive time to open the bag carefully, and to avoid ripping of the thin plastic film.

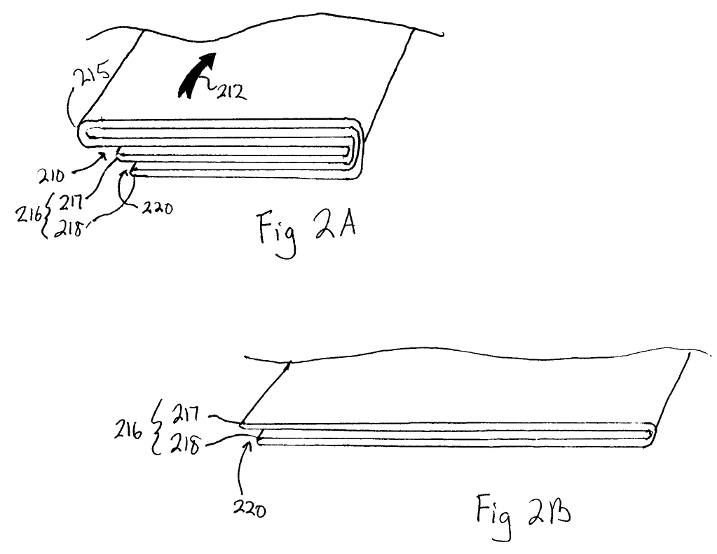

Referring now to FIG. 2A, a contemplated embodiment of the present invention is depicted. The offset folded bag 200 is depicted with a primary opening 210 between the top four layers 215 of the offset folded bag 200 and the lower four layers 216. In this particular embodiment, the lower four layers 216 are comprised of an upper two layers 217 and a lower two layers 218 which have a secondary opening 220 located between them.

It is desirable for the consumer to open the offset folded bag 200 by first using the primary opening 210. To enhance the likelihood that the consumer will utilize primary opening 210, the offset folded bag 200 is folded so that the upper four layers 215 of the offset folded bag 200 extend slightly beyond the lower four layers 216 of the folded bag. This offset is generally on the order of several millimeters to a centimeter. This minimal offset makes it much easier for the consumer to identify the proper opening 210 between the upper four layers 215 and the lower four layers 216.

The resulting partially-unfolded bag is better depicted with reference to FIG. 2B. Furthermore, as the bag is still significantly narrower than the anticipated width of the bag, it is clear to the consumer that the bag must be again unfolded, this time at secondary opening 220 between the upper two layers 217 and the lower two layers 218. The consumer instantly recognizes the bag needs further opening and thus unfolds the bag at secondary opening 220, avoiding the problems identified with respect to the embodiment of FIGS. 1A-1E.

It may also be advantageous to provide a slight offset between the upper two layers 217 and the lower two layers 218 to better assist the consumer in identifying secondary opening 220. Although the offset of the secondary opening 220 will be smaller than the offset for the primary opening 210, it may be on the order of a couple of millimeters. As noted before, the translucent properties of the thin plastic will visually assist the consumer in identifying the secondary opening 220 as the upper two layers 217 by itself will not be as opaque as the combination of the lower two layers 218 and the upper two layers 218.

The embodiment described herein is used to describe the general properties and features of the invention. It is not intended to limit the scope of the invention in any way. Rather, the scope of the invention is better defined by the claims appended hereto, which should be read in view of this specification and the appended figures. A person having ordinary skill in the art will instantly recognize that additional embodiments and configurations may be utilized without diverging from the scope or spirit of the present invention.

What is claimed is:

1. An offset folded polymeric bag, comprising:
a folded polymeric bag, the folded polymeric bag comprising a flattened polymeric bag folded at least one time longitudinally, the folded polymeric bag defining a transverse width,
the folded polymeric bag defining a plurality of layers, all of the plurality of layers being substantially parallel, wherein the plurality of layers comprises a first set of layers and a second set of layers, the first set of layers and the second set of layers being mutually exclusive but comprising all of the plurality of layers,
wherein a primary opening is defined between the first set of layers and the second set of layers along a first side of the folded polymeric bag, and
wherein the first set of layers and the second set of layers have a difference of width in the transverse direction

2. The offset folded polymeric bag of claim 1, wherein the difference of width in the transverse direction between the first set of layers and the second set of layers is between 1 mm and 20 mm.

3. The offset folded polymeric bag of claim 1, wherein the difference of width in the transverse direction between the first set of layers and the second set of layers is between 2 mm and 10 mm.

4. The offset folded polymeric bag of claim 1, wherein the first set of layers and the second set of layers are interconnected along a second side of the folded polymeric bag opposite the first side of the folded polymeric bag.

5. The offset folded polymeric bag of claim 1, wherein the first set of layers is an upper four layers of the plurality of layers and the second set of layers is a lower four layers of the plurality of layers, the plurality of layers comprising eight layers total.

6. The offset folded polymeric bag of claim 1, wherein an upper-most layer of the upper four layers is directly connected to the bottom-most layer of the upper four layers.

7. The offset folded polymeric bag of claim 1, wherein the folded polymeric bag is in a double V-fold configuration.

8. The offset folded polymeric bag of claim 1, wherein:
the second set of layers comprises a first subset of layers and a second subset of layers, the first subset of layers and the second subset of layers being mutually exclusive but comprising all of the second set of layers, and
wherein a secondary opening for unfolding is defined between the first subset of layers and the second subset of layers, and
wherein the first subset of layers and the second subset of layers have a difference of width in the transverse direction.

9. The offset folded polymeric bag of claim 8, wherein the difference of width in the transverse direction between the first set of layers and the second set of layers is greater than the difference in width between the first subset of layers and the second subset of layers.

10. The offset folded polymeric bag of claim 9, wherein the difference in width between the first subset of layers and the second subset of layers is less than 20 mm.

11. The offset folded polymeric bag of claim 9, wherein the difference in width between the first subset of layers and the second subset of layers is less than 10 mm.

12. The offset folded polymeric bag of claim 8, wherein a top layer of the first subset of layers is directly connected to a bottom layer of the first subset of layers, and wherein a top layer of the second subset of layers is directly connected to a bottom layer of the second subset of layers.

13. A method of providing an offset folded polymeric bag, comprising the steps of:
(a) providing a polymeric bag, the polymeric bag being initially flat, wherein the polymeric bag has a longitudinal direction extending generally from an upper opening of the bag to a bottom of the bag and a transverse direction perpendicular to the longitudinal direction, and
(b) folding the polymeric bag transversely over a first longitudinal line to provide an offset folded polymeric bag, wherein a first edge of the offset folded polymeric bag is farther from the first longitudinal line than a second edge of the offset folded polymeric bag.

14. The method of claim 13, further comprising the step of:
(c) folding the polymeric bag transversely over a second longitudinal line to provide a partially folded polymeric bag, wherein step (c) is performed before step (b).

15. The method of claim 14, wherein the a first edge of the partially folded polymeric bag is farther from the second longitudinal line than a second edge of the partially folded polymeric bag.
